(19) United States
(12) Patent Application Publication
(10) Pub. No.: US 2020/0304167 A1
(43) Pub. Date: Sep. 24, 2020

(54) FRONT END MODULE

(71) Applicant: Samsung Electro-Mechanics Co., Ltd., Suwon-si (KR)

(72) Inventors: Jae Wook KWON, Suwon-si (KR); Yun Tae LEE, Suwon-si (KR); Seong Jong CHEON, Suwon-si (KR); Sung Jae YOON, Suwon-si (KR); Jin O YOO, Suwon-si (KR)

(73) Assignee: Samsung Electro-Mechanics Co., Ltd., Suwon-si (KR)

(21) Appl. No.: 16/508,650

(22) Filed: Jul. 11, 2019

(30) Foreign Application Priority Data
Mar. 18, 2019 (KR) 10-2019-0030515

(51) Int. Cl. H04B 1/50; H04B 1/00

(52) U.S. Cl. CPC H04B 1/50; H04B 1/0057

(57) ABSTRACT

A front end module includes: a first filter and a second filter, the first filter and the second filter being configured to respectively support cellular communications in different frequency bands among a first frequency band and a second frequency band of a sub-6 GHz band; a third filter configured to support Wi-Fi communications in a third frequency band of a 5 GHz band, and having one end connected to an antenna terminal; and a switch configured to selectively connect one end of the first filter and one end of the second filter to the antenna terminal.

### CROSS-REFERENCE TO RELATED APPLICATIONS

This application claims the benefit under 35 U.S.C. § 119(a) of Korean Patent Application No. 10-2019-0030515 filed on Mar. 18, 2019 in the Korean Intellectual Property Office, the entire disclosure of which is incorporated herein by reference for all purposes.

### BACKGROUND

### 1. Field

The following description relates to a front end module.

### 2. Description of Related Art

Fifth generation (5G) communications are expected to connect more devices efficiently at a higher data rate and a faster data transfer rate, compared to existing Long Term Evolution (LTE) communications.

5th generation mobile communications are developing in the direction of using a frequency band of 24,250 MHz to 52,600 MHz, corresponding to millimeter wave (mmWave) and a frequency band of 450 MHz to 6000 MHz corresponding to sub-6 GHz.

The sub-6 GHz frequency band is expected to be commercialized in a number of countries, due to the similarity of technology based on band proximity to existing 4th generation (4G) communications. Each of the n77 (3300 MHz to 4200 MHz) band and the n79 (4400 MHz to 5000 MHz) band is defined as one of the sub-6 GHz operating bands. The n77 (3300 MHz to 4200 MHz) band and the n79 (4400 MH to 5000 MHz) band will be used as the main bands due to relatively wide bandwidths.

At sub-6 GHz, a 4*4 Multi-Input/Multi-Output (MIMO) system is essentially applied to improve frequency efficiency. MIMO is a technique in which the bandwidth may increase in proportion to the number of antennas. In a case in which four antennas are used, four times the frequency efficiency of a single antenna may be obtained. However, due to the slimming and miniaturization of mobile devices, there is a limitation in the space in which an antenna is mounted, and physical limitations may be present in additionally implementing four antennas in a terminal, under the condition that antennas used in an existing system are provided.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a front end module includes: a first filter and a second filter, the first filter and the second filter being configured to respectively support cellular communications in different frequency bands among a first frequency band and a second frequency band of a sub-6 GHz band; a third filter configured to support Wi-Fi communications in a third frequency band of a 5 GHz band, and having one end connected to an antenna terminal; and a switch configured to selectively connect one end of the first filter and one end of the second filter to the antenna terminal.

The first filter, the second filter, and the third filter may be configured to operate as band-pass filters.

The first frequency band may be a frequency band from 3.3 GHz to 4.2 GHz.

The second frequency band may be a frequency band from 4.4 GHz to 5.0 GHz.

The third frequency band may be a frequency band from 5.15 GHz to 5.825 GHz.

The third filter may have attenuation characteristics of 35 dB to 40 dB.

The front end module may further include a diplexer including a high-pass filter connected to the antenna terminal, and a low-pass filter connected to the antenna terminal.

The high-pass filter may be connected to the switch and the second filter. The low-pass filter may be connected to a signal processing device configured to support Wi-Fi communications in a 2.4 GHz band.

The antenna terminal may be connected to a single antenna configured to transmit and receive signals of the cellular communications and the Wi-Fi communications.

In another general aspect, a front end module includes: a first filter and a second filter, the first filter and the second filter being configured to respectively support cellular communications in different frequency bands from among a first frequency band and a second frequency band of a sub-6 GHz band; a third filter configured to support Wi-Fi communications in a third frequency band of a 5 GHz band; and a switch configured to selectively connect one end of the first filter, one end of the second filter, and one end of the third filter to an antenna terminal.

The first filter, the second filter, and the third filter may be configured to operate as band-pass filters.

The first frequency band may be a frequency band from 3.3 GHz to 4.2 GHz.

The second frequency band may be a frequency band from 4.4 GHz to 5.0 GHz.

The third frequency band may be a frequency band from 5.15 GHz to 5.825 GHz.

The front end module may further include a diplexer including a high-pass filter connected to the antenna terminal, and a low-pass filter connected to the antenna terminal.

The high-pass filter may be connected to the switch. The low-pass filter may be connected to a signal processing device configured to support Wi-Fi communications in a 2.4 GHz band.

The high-pass filter may have a lower limit frequency of 3.3 GHz. The low pass filter may have an upper limit frequency of 2.7 GHz.

The antenna terminal may be connected to a single antenna configured to transmit and receive signals of the cellular communications and the Wi-Fi communications.

Other features and aspects will be apparent from the following detailed description, the drawings, and the claims.

### BRIEF DESCRIPTION OF DRAWINGS

FIG. 1 is a block diagram of a mobile device on which a front end module, according to an example, is mounted.

FIG. 2 is a block diagram of a front end module, according to an example.

FIG. 3 illustrates a frequency response of a first filter, a second filter, and a third filter, according to an example.

FIG. 4 is a modified example of the front end module of FIG. 2.

FIG. 5 is a block diagram illustrating a signal processing device connected to a terminal, according to an example.

FIG. 6 is a block diagram of a front end module, according to an example.

FIG. 7 is a modified example of the front end module of FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

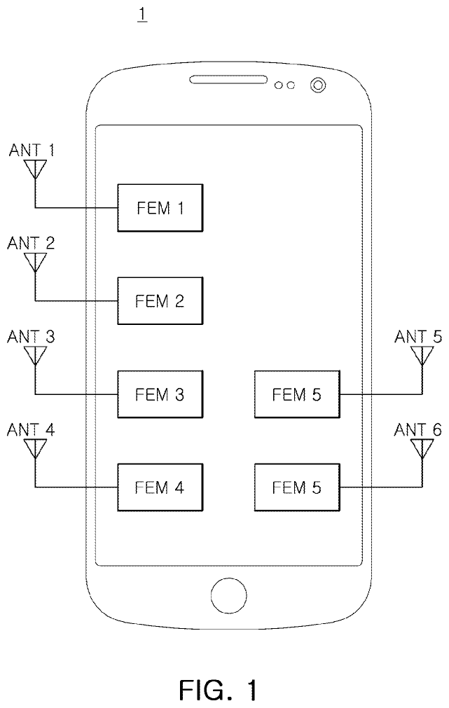

FIG. 1 is a block diagram of a mobile device 1 equipped with a front end module, according to an example.

Referring to FIG. 1, the mobile device 1 includes antennas ANT1 to ANT6 and front end modules FEM1 to FEM6. The front end modules FEM1 to FEM6 are respectively connected to different ones of the antennas ANT1 to ANT6.

The mobile device 1 performs various standard wireless communications such as cellular (LTE/WCDMA/GSM) communications, 2.4 GHz and 5 GHz Wi-Fi communications, Bluetooth communications and the like. The antennas ANT1 to ANT6 and the front end modules FEM1 to FEM6 included in the mobile device support various standard wireless communications.

However, in a case in which the antennas ANT1 to ANT6 are employed in a limited space of the mobile device 1, RF signals input and output to and from the antennas ANT1 to ANT6 interfere with each other, thereby causing performance deterioration of the antennas ANT1 to ANT6.

Therefore, the number of antennas mounted on the mobile device 1 is required to be reduced by allowing a front end module connected to any one of the antennas to support a plurality of standard wireless communications.

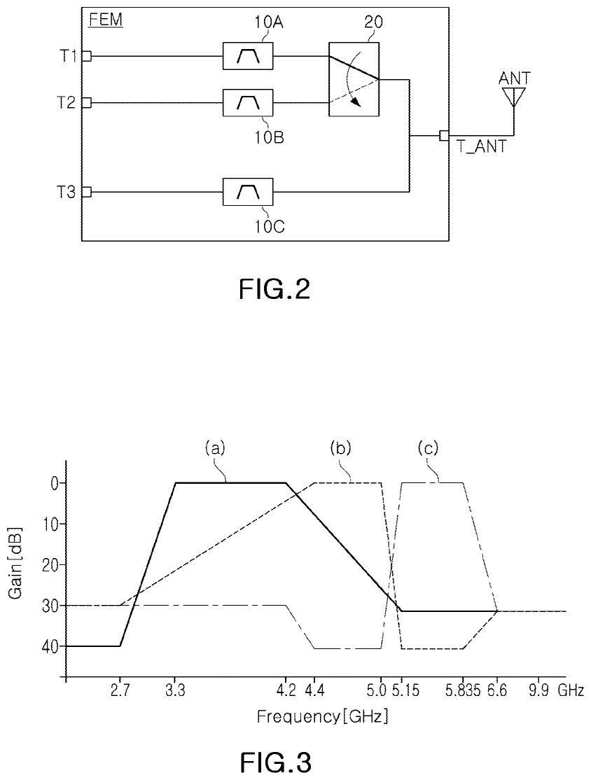

FIG. 2 is a block diagram of a front end module, according to an example. FIG. 3 illustrates frequency responses of a first filter 10A, a second filter 10B, and a third filter 100, according to an example. More specifically, in FIG. 3, graph (a) illustrates the frequency response of the first filter 10A, graph (b) illustrates the frequency response of the second filter 10B, and graph (c) illustrates the frequency response of the third filter 10C.

The front end module includes the first filter 10A, the second filter 10B, the third filter 10C, and a switch 20. The first filter 10A, the second filter 10B, the third filter 10C, and the switch 20 may be implemented by a single chip.

One end of the first filter 10A is connected to the switch 20, and the other end of the first filter 10A is connected to a first terminal T1. One end of the second filter 10B is connected to the switch 20, and the other end of the second filter 10B is connected to a second terminal T2. One end of the third filter 10C is connected to the antenna terminal T_ANT, and the other end of the third filter 100 is connected to the third terminal T3. An antenna ANT for transmitting and receiving an RF signal is connected to the antenna terminal T_ANT.

One side of the switch 20 is connected to the first filter 10A and the second filter 10B, and the other side of the switch 20 is connected to the antenna terminal T_ANT. The switch 20 is, for example, implemented as a three-terminal switch in the form of a single pole double throw (SPDT). One end of each of the first filter 10A and one end of the second filter 10B may be selectively connected to the antenna terminal T_ANT through the switch 20.

The first filter 10A and the second filter 10B support cellular communications in a first frequency band and a second frequency band that are preset in the Sub-6 GHz band. For example, the first filter 10A may support cellular communications in a 3.3 GHz to 4.2 GHz band corresponding to the first frequency band, and the second filter 10B may support the cellular communications in a 4.4 GHz to 5.0 GHz band corresponding to the second frequency band.

The first filter 10A and the second filter 10B operate as band-pass filters. For example, the first filter 10A may operate as a band-pass filter having a lower limit frequency of 3.3 GHz and an upper limit frequency of 4.2 GHz, and the second filter 10B may operate as a band-pass filter having a low limit frequency of 4.4 GHz and an upper limit frequency of 5.0 GHz.

The third filter 10C supports Wi-Fi communications in a predetermined third frequency band in the 5 GHz band. For example, the third filter 10C may support Wi-Fi communications in the 5.15 GHz to 5.825 GHz band corresponding to the third frequency band.

The third filter 10C operates as a band-pass filter. For example, the third filter 10C may operate as a band-pass filter having a lower limit frequency of 5.15 GHz and an upper limit frequency of 5.825 GHz.

According to an example, the first filter 10A and the second filter 10B, which support cellular communications in the Sub-6 GHz band, and the third filter 100, which supports Wi-Fi communications in the 5 GHz band, constitute a single front end module. By connecting the front end module to one antenna ANT, the number of antennas provided in the mobile device may be significantly reduced. Therefore, communication performance of a mobile device may be improved by preventing the RF signals output from different antennas from interfering with each other. Furthermore, filters that support different standards may be integrated into a single front end module to reduce an overall area of the front end module.

Referring to FIG. 2, the first filter 10A, the second filter 10B, and the third filter 10C may be required to have relatively high attenuation characteristics for co-existence of the sub-6 GHz band cellular communications and the 5 GHz band Wi-Fi communications.

For example, the first filter 10A and the second filter 10B selectively receive the RF signal having a frequency band supported by each of the first filter 10A and the second filter 10B, depending on a switching operation of the switch 20, while the third filter 10C is directly connected to the antenna terminal T_ANT to receive an RF signal having a different frequency band as well as an RF signal having a frequency band supported by the third filter 10C. Therefore, the third filter 10C is required to have attenuation characteristics higher than those of the first filter 10A and the second filter 10B.

According to an example, for co-existence of cellular communications in the 3.3 GHz to 4.2 GHz band and cellular communications in the 4.4 GHz to 5.0 GHz band, the third filter 100 supporting Wi-Fi communications in the 5.15 GHz to 5.825 GHz band may have an attenuation characteristic of 35 to 40 dB.

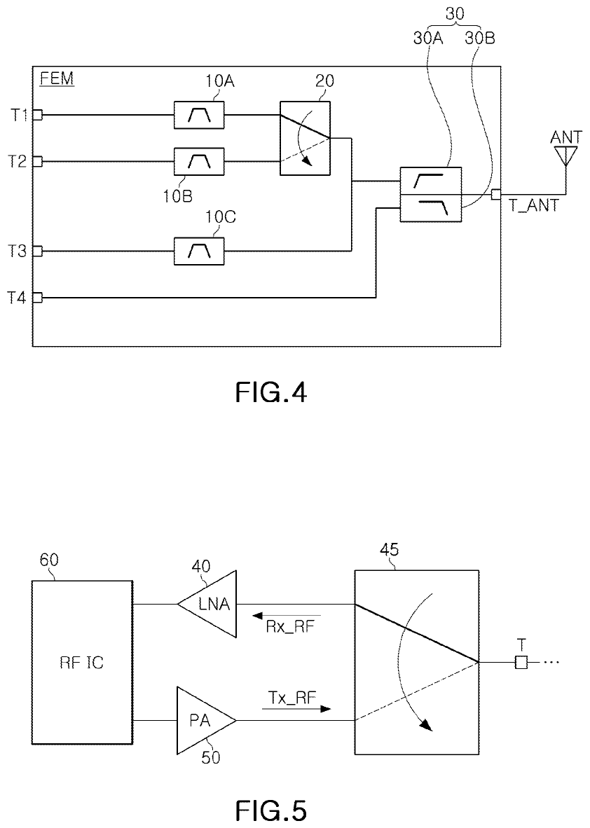

FIG. 4 is a modified example of the front end module of FIG. 2.

Since the configuration of the front end module according to an example of FIG. 4 is similar to that of the front end module according to the example of FIG. 2, overlapping descriptions thereof will be omitted, and mainly differences therebetween will be described.

Referring to FIG. 4, the front end module may further include a diplexer 30. The diplexer 30 includes a high-pass filter 30A and a low-pass filter 30B. One end of the high pass filter 30A is connected to the antenna terminal T_ANT, and the other end of the high pass filter 30A is connected to the switch 20 and the third filter 10C. The low-pass filter 30B has one end connected to the antenna terminal T_ANT and another end connected to a fourth terminal T4.

The high-pass filter 30A has a lower limit frequency corresponding to a first reference frequency. As an example, the first reference frequency may be 3.3 GHz. Further, the low-pass filter 30B may have an upper limit frequency corresponding to a second reference frequency. As an example, the second reference frequency may be 2.7 GHz.

An RF signal having a frequency equal to or higher than the first reference frequency, having passed through the high pass filter 30A, is selectively provided to the first filter 10A and the second filter 10B through the switch 20 connected to the high pass filter 30A. In addition, the RF signal of the first reference frequency or higher, having passed through the high-pass filter 30A, is provided to the third filter 10C directly from the high-pass filter 30A.

An RF signal having a frequency equal to or lower than the second reference frequency, having passed through the low-pass filter 30B, is provided to the fourth terminal T4 connected to the low-pass filter 30B. The fourth terminal T4 may be connected to a signal processing device supporting Wi-Fi communications in the 2.4 GHz band.

Therefore, the front end module of FIG. 4 may perform Wi-Fi communications in the 2.4 GHz band, in addition to the sub-6 GHz band cellular communications and the 5 GHz band Wi-Fi communications.

Although FIG. 4 illustrates a case in which the low-pass filter 30B and the fourth terminal T4 are directly connected to each other, a separate filter may be disposed between the low-pass filter 30B and the fourth terminal T4, according to an example. The filter disposed between the low-pass filter 30B and the fourth terminal T4 may operate as a band-pass filter including a lower-limit frequency of 2.4 GHz and an upper-limit frequency of 2.4835 GHz, thereby supporting Wi-Fi communications in the 2.4 GHz to 2.4835 GHz band.

FIG. 5 is a block diagram illustrating a signal processing device connected to a terminal, according to an example.

In FIG. 5, a terminal T may correspond to any one of the first terminal T1 to the fourth terminal T4 in FIGS. 2 and 4.

Referring to FIG. 5, the terminal T is respectively connected to one end of a low noise amplifier (LNA) and one end of a power amplifier (PA) 50 through a switch 45. The low noise amplifier 40 may be disposed in a reception path Rx_RF of an RF signal, and the power amplifier 50 may be disposed in a transmission path Tx_RF of the radio frequency signal. The other end of the low noise amplifier (LNA) and the other end of the power amplifier (PA) 50 may be connected to a radio frequency integrated circuit (RF IC) 60.

The RF IC 60 outputs, an RF signal transmitted through an antenna ANT, via the transmission path Tx_RF, and receives the RF signal received via the antenna ANT, via the reception path RX_RF.

Although FIG. 5 illustrates the case in which the low-noise amplifier 40 is disposed in the reception path Rx_RF and the power amplifier 50 is disposed in the transmission path Tx_RF, the low noise amplifier 40 may be removed from the reception path Rx_RF, or the power amplifier 50 may be removed from the transmission path Tx_RF, depending on whether a need for amplification exists based on a design.

The low noise amplifier 40, the power amplifier 50 and the RF IC 60 illustrated in FIG. 5 may constitute a front end module together with the first filter 10A, the second filter 10B, the third filter 10C, the switch 20 and the diplexer 30 illustrated in FIGS. 2 and 4. The first filter 10A, the second filter 10B, the third filter 10C, the switch 20, the diplexer 30, the low noise amplifier 40, the switch 45, the power amplifier 50 and the RF IC 60 may be implemented as a single chip.

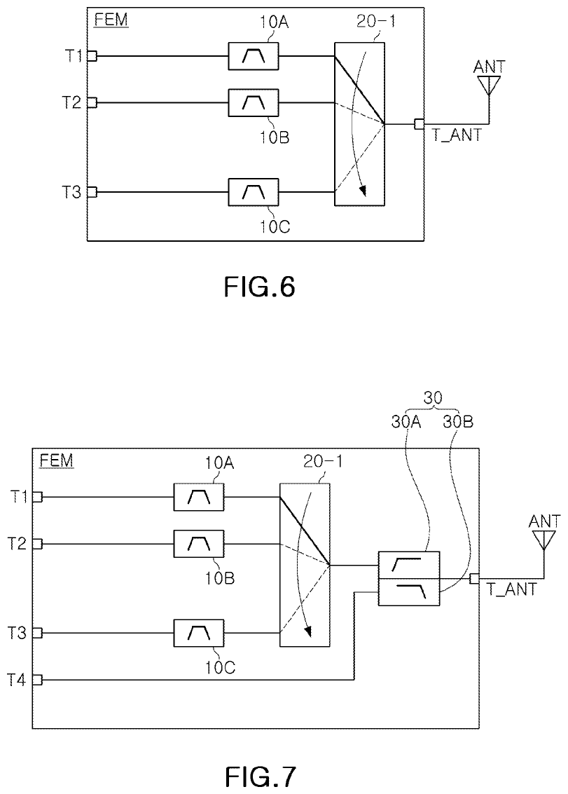

FIG. 6 is a block diagram of a front end module, according to another example.

Since the front end module according to an example of FIG. 6 is similar to the front end module according to the example of FIG. 2, an overlapping description will be omitted, and mainly differences therebetween will be described.

Referring to FIG. 6, the front end includes the first filter 10A, the second filter 10B, the third filter 10C, and a switch 20-1.

One end of the first filter 10A is connected to the switch 20-1, and the other end of the first switch 10A is connected to a first terminal T1. One end of the second filter 10B is connected to the switch 20-1, and the other end of the second filter 10B is connected to a second terminal T2. One end of the third filter 10C is connected to the switch 20-1, and the other end of the third switch 10C is connected to the third terminal T3. The antenna terminal T_ANT is connected to the antenna ANT transmitting and receiving an RF signal.

One side of the switch 20-1 is connected to the first filter 10A, the second filter 10B and the third filter 100, and the other side of the switch 20-1 is connected to the antenna terminal T_ANT. The switch 20-1 is implemented, for example, as a four terminal switch in the form of a single pole triple throw (SP3T). One end of each of the first filter 10A, the second filter 10B and the third filter 10C may be selectively connected to the antenna terminal T_ANT via the switch 20-1.

Referring to FIG. 6, the first filter 10A, the second filter 10B, and the third filter 10C may be required to have relatively high attenuation characteristics for co-existence of the sub-6 GHz band cellular communications and the 5 GHz band Wi-Fi communications.

The first filter 10A, the second filter 10B and the third filter 10C of the front end module according to the example of FIG. 6 may receive an RF signal having a frequency band respectively supported by the first filter 10A, the second filter 10B, and the third filter 100, depending on a switching operation of the switch 20-1, and thus, may have relatively lower attenuation characteristics as compared with the example of FIG. 2. Therefore, manufacturing costs of the first filter 10A, the second filter 10B, and the third filter 10C may be reduced.

FIG. 7 is a modified example of the front end module according to the example of FIG. 6.

Since the front end module according to the example of FIG. 7 is similar to the front end module according to the example of FIG. 6, descriptions thereof will be omitted, and mainly differences therebetween will be described.

Referring to FIG. 7, the front end module may further include the diplexer 30. The diplexer 30 includes the high-pass filter 30A and the low-pass filter 30B. One end of the high pass filter 30A is connected to the antenna terminal T_ANT, and the other end of the high pass filter 30A is connected to the switch 20-1. The low-pass filter 30B has one end connected to the antenna terminal T_ANT and another end connected to the fourth terminal T4.

An RF signal having a frequency equal to or higher than a first reference frequency, having passed through the high pass filter 30A, is selectively provided to the first filter 10A, the second filter 10B and the third filter 10C, through the switch 20-1 connected to the high pass filter 30A.

An RF signal having a frequency equal to or lower than a second reference frequency, having passed through the low-pass filter 30B, is provided to the fourth terminal T4 connected to the low-pass filter 30B. A signal processing device performing Wi-Fi communications in the 2.4 GHz band may be connected to the fourth terminal T4.

Therefore, the front end module according to the example of FIG. 7 may perform Wi-Fi communications in the 2.4 GHz band in addition to the sub-6 GHz band cellular communications and the 5 GHz band Wi-Fi communications.

According to examples disclosed herein, isolation characteristics of antennas may be improved, by directly or indirectly connecting filters supporting different communications standards to a single antenna, to reduce the number of antennas employed in a mobile device.

As set forth above, according to an example, isolation characteristics of antennas may be improved by reducing the number of antennas employed in a mobile device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A front end module, comprising:
a first filter and a second filter, the first filter and the second filter being configured to respectively support cellular communications in different frequency bands among a first frequency band and a second frequency band of a sub-6 GHz band;
a third filter configured to support Wi-Fi communications in a third frequency band of a 5 GHz band, and having one end connected to an antenna terminal; and
a switch configured to selectively connect one end of the first filter and one end of the second filter to the antenna terminal.

2. The front end module of claim 1, wherein the first filter, the second filter, and the third filter are configured to operate as band-pass filters.

3. The front end module of claim 1, wherein the first frequency band is a frequency band from 3.3 GHz to 4.2 GHz.

4. The front end module of claim 1, wherein the second frequency band is a frequency band from 4.4 GHz to 5.0 GHz.

5. The front end module of claim 1, wherein the third frequency band is a frequency band from 5.15 GHz to 5.825 GHz.

6. The front end module of claim 1, wherein the third filter has attenuation characteristics of 35 dB to 40 dB.

7. The front end module of claim 1, further comprising a diplexer including a high-pass filter connected to the antenna terminal, and a low-pass filter connected to the antenna terminal.

8. The front end module of claim 7, wherein the high-pass filter is connected to the switch and the second filter, and
wherein the low-pass filter is connected to a signal processing device configured to support Wi-Fi communications in a 2.4 GHz band.

9. The front end module of claim 1, wherein the antenna terminal is connected to a single antenna configured to transmit and receive signals of the cellular communications and the Wi-Fi communications.

10. A front end module, comprising:
a first filter and a second filter, the first filter and the second filter being configured to respectively support cellular communications in different frequency bands from among a first frequency band and a second frequency band of a sub-6 GHz band;
a third filter configured to support Wi-Fi communications in a third frequency band of a 5 GHz band; and
a switch configured to selectively connect one end of the first filter, one end of the second filter, and one end of the third filter to an antenna terminal.

11. The front end module of claim 10, wherein the first filter, the second filter, and the third filter are configured to operate as band-pass filters.

12. The front end module of claim 10, wherein the first frequency band is a frequency band from 3.3 GHz to 4.2 GHz.

13. The front end module of claim 10, wherein the second frequency band is a frequency band from 4.4 GHz to 5.0 GHz.

14. The front end module of claim 10, wherein the third frequency band is a frequency band from 5.15 GHz to 5.825 GHz.

15. The front end module of claim 10, further comprising a diplexer including a high-pass filter connected to the antenna terminal, and a low-pass filter connected to the antenna terminal.

16. The front end module of claim 15, wherein the high-pass filter is connected to the switch, and
wherein the low-pass filter is connected to a signal processing device configured to support Wi-Fi communications in a 2.4 GHz band.

17. The front end module of claim 15, wherein the high-pass filter has a lower limit frequency of 3.3 GHz, and the low pass filter has an upper limit frequency of 2.7 GHz.

18. The front end module of claim 10, wherein the antenna terminal is connected to a single antenna configured to transmit and receive signals of the cellular communications and the Wi-Fi communications.
